(19) United States
(12) Patent Application Publication
(10) Pub. No.: US 2004/0263020 A1
(43) Pub. Date: Dec. 30, 2004

(54) ROTOR SLOT INSULATION FOR TURBINE-GENERATORS AND METHOD AND SYSTEM OF MANUFACTURE

(75) Inventors: Patricia Chapman Irwin, Altamont, NY (US); James Jonathan Grant, Niskayuna, NY (US); Hsin-Pang Wang, Rexford, NY (US)

Correspondence Address: NIXON & VANDERHYE P.C./G.E., 1100 N. GLEBE RD., SUITE 800, ARLINGTON, VA, 22201, US

(73) Assignee: GENERAL ELECTRIC COMPANY, Schenectady, NY (US)

(21) Appl. No.: 10/604,054

(22) Filed: Jun. 24, 2003

(51) Int. Cl. B32B 7/02; H02K 3/34

(52) U.S. Cl. 310/215; 428/212

(57) ABSTRACT

A slot armor component for use in a rotor of a dynamo-electric machine comprises a profile extruded material having a first leg portion and a second leg portion disposed at an angle to the first leg portion, the second leg portion being shorter and thicker than the first leg portion. The material may be glass-filled polyetheretherketone (PEEK) such as a less than or equal to 30% (â [symbol] 30%) glass-filled polyetheretherketone (PEEK). Alternatively, the material may be unfilled polyetheretherketone (PEEK), glass-filled Ultem such as less than or equal to 30% (â [symbol] 30%) glass-filled Ultem, or unfilled Ultem.

### CROSS REFERENCE TO RELATED APPLICATIONS

This application is related to commonly assigned U.S. application Ser. No. ______ (Attorney Docket no. 839-1405) entitled Multilayer Co-extrusion Rotor Slot Armor and System for Making the Same, filed concurrently herewith and naming Irwin et al. as inventors, the contents of which are incorporated herein by reference.

### BACKGROUND OF INVENTION

This invention relates to slot insulation for a rotor of a dynamo-electric machine, and particularly to profile extruded slot armor for a rotor of a dynamo-electric machine.

Dynamo-electric machines such as power generators include a rotor mounted within a stator. The rotor is an electromagnet that includes field coils typically made of copper or aluminum. A body of the rotor, typically made of steel, includes multiple axial slots. The field coils are arranged within these axial slots and produce a magnetic flux pattern when supplied with electrical current. A turbine (e.g., a gas or steam turbine) rotates the rotor including the field coils so that the magnetic flux pattern interacts with windings of the stator to generate electrical power.

The field coils must be electrically and mechanically isolated from the rotor body via rotor slot insulation. This insulation is typically designed to withstand the electrical, mechanical and thermal forces induced during normal operation of the dynamo-electric machine for twenty years or more. The insulation often includes multiple parts such as slot armor and sub-slot covers. These parts serve to position and protect the field coils from electrical contact with the rotor body. Specifically, the slot armor insulates the field coil's sides. The slot armor also provides electrical creepage distance at the radially inner (bottom) portion of the field coils and the radially outer (top) portion of the field coils. The sub-slot covers provide additional insulation and creepage distance between the radially inner portion of the field coils and the rotor body.

Various shapes and configurations of rotor slot insulation are known. For example, U.S. Pat. No. 4,162,340 to Fuchs discloses rotor slot insulation having an L-shaped profile or a U-shaped profile of laminated and compressed substances. A partial area of the rotor slot insulation such as the shorter leg (i.e., foot) of the L-shaped profile or the base of the U-shaped profile is thickened. U.S. Pat. No. 5,065,064 to Kaminski discloses rotor slot insulation which eliminates the need for a sub-slot cover through the use of rotor slot armors having Z-shaped profiles. As yet another example, U.S. Pat. No. 4,560,896 to Vogt et al. discloses a composite slot armor and sub-slot cover having a one-piece, integrally molded construction.

There are two manufacturing processes which are commonly used to produce rotor slot armor for large turbine-generators. One process entails an autoclave process which involves producing a laminated composite armor comprising aramid paper (e.g., Nomexâ [symbol] ), polyimide film (e.g., Kaptonâ [symbol] ), woven glass fabric, and epoxy. The other process utilizes a compression-step-molding process using similar materials. U.S. Pat. No. 3,974,314 to Fuchs, U.S. Pat. No. 4,473,765 to Butman, Jr. et al., and U.S. Pat. No. 4,582,749 to Boulter et al. disclose further examples of various materials used to produce rotor slot armor.

The current processes for manufacturing rotor slot armor are laborious. Also, expensive materials and equipment are needed. The processes are difficult to control and often produce high scrap rates and/or inconsistent product quality. The processes also impose limitations on the design of the cross-sectional shapes of armor that may be produced. Furthermore, composite laminate slot armor produced using these manufacturing processes may not possess the mechanical properties that make it easy and/or effective to assemble into the rotor body.

Accordingly, there remains a need for a process for manufacturing rotor slot armor which is relatively inexpensive and which can accommodate a large variety of shapes and thicknesses. There also remains a need for a rotor slot armor material which exhibits long life and other beneficial mechanical properties such as high flexural modulus, flexual strength, angular strength, electrical creepage, and dielectric strength as well as low moisture absorption and improved solvent resistance for reducing electrical failures due to chemical contamination.

### SUMMARY OF INVENTION

In one aspect of the present invention, a slot armor component for use in a rotor of a dynamo-electric machine comprises a profile extruded material having a first leg portion and a second leg portion disposed at an angle to the first leg portion, the second leg portion being shorter and thicker than the first leg portion. The material may be glass-filled polyetheretherketone (PEEK) such as less than or equal to 30% (â [symbol] 30%) glass-filled polyetheretherketone (PEEK). Alternatively, the material may be unfilled polyetheretherketone (PEEK), glass-filled Ultem such as a less than or equal to 30% (â [symbol] 30%) glass-filled Ultem, or unfilled Ultem.

The second leg portion may include (i) a connection portion integrally connected to the first leg portion, and (ii) a tip portion integrally connected to the connection portion, the tip portion having a width which tapers as the tip portion extends away from the connection portion. The second leg portion may include (i) a first surface which extends perpendicularly to the first leg portion, and (ii) a second surface, opposite to the first surface, which extends at an angle less than perpendicular to the first leg portion. The second leg portion may include an internal skeleton structure. Alternatively, the second leg portion may be completely filled.

In another aspect of the present invention, a slot armor material for use in a rotor of a dynamo-electric machine comprises glass-filled polyetheretherketone (PEEK) such as a less than or equal to 30% (â [symbol] 30%) glass-filled polyetheretherketone (PEEK). The glass-filled PEEK material may be a profile extruded material such as one including a first leg portion and a second leg portion disposed at an angle to the first leg portion, the second leg portion being shorter and thicker than the first leg portion.

In another aspect of the present invention, a slot armor material for use in a rotor of a dynamo-electric machine comprises an unfilled polyetheretherketone (PEEK). The unfilled PEEK material may be a profile extruded material such as one including a first leg portion and a second leg portion disposed at an angle to the first leg portion, the second leg portion being shorter and thicker than the first leg portion.

In another aspect of the present invention, a slot armor material for use in a rotor of a dynamo-electric machine comprises glass-filled Ultem such as a less than or equal to 30% (â [symbol] 30%) glass-filled Ultem. The glass-filled Ultem material may be a profile extruded material such as one including a first leg portion and a second leg portion disposed at an angle to the first leg portion, the second leg portion being shorter and thicker than the first leg portion.

In another aspect of the present invention, a slot armor material for use in a rotor of a dynamo-electric machine comprises an unfilled Ultem. The unfilled Ultem material may be a profile extruded material such as one including a first leg portion and a second leg portion disposed at an angle to the first leg portion, the second leg portion being shorter and thicker than the first leg portion.

In another aspect of the present invention, a profile extrusion system comprises an extruder for melting a material, a profile extrusion die operatively coupled to the extruder so that the die receives the material melted by the extruder, and a calibrator. The die includes: a plate having a first slot and a second slot defined therein so that the material passes through the first slot and the second slot, a mandrel inserted into the second slot of the plate for controlling a flow rate of the material passing through the second slot, and a land having a profile-shaped slot defined therein for providing a profile shape to the material that has passed through the first and second slots of the plate.

The mandrel may slow the flow rate of the material passing through the second slot so that the material passes through all portions of the profile-shaped slot of the land at a uniform flow rate. The profile-shaped slot of the land may have a first slot portion and a second slot portion disposed at an angle to the first slot portion, the second slot portion being wider and shorter than the first slot portion. The first slot of the plate may be aligned with the first slot portion of the land so that at least some of the material that has passed through the first slot passes through the first slot portion and the second slot of the plate may be aligned with the second slot portion of the land so that at least some of the material that has passed through the second slot passes through the second slot portion. The mandrel may slow the flow rate of the material passing through the second slot of the plate so that the material passes through the first and second slot portions at a uniform flow rate.

### BRIEF DESCRIPTION OF DRAWINGS

FIG. 1 is a side view of a rotor slot armor component according to the prior art;

FIG. 2 is a front view of the rotor slot armor component illustrated in FIG. 1 according to the prior art;

FIG. 3 is a perspective view of the rotor slot armor component illustrated in FIGS. 1 and 2 according to the prior art;

FIG. 4 is a partial view of a rotor of a dynamo-electric machine having rotor slot armor components according to an exemplary embodiment of the present invention;

FIG. 5 is a side view of a rotor slot armor component in accordance with an exemplary embodiment of the present invention;

FIG. 6 is a front view of the rotor slot armor component illustrated in FIG. 5;

FIG. 7 is a perspective view of the rotor slot armor component illustrated in FIGS. 5 and 6;

FIG. 8 is a side view of a rotor slot armor component in accordance with another exemplary embodiment of the present invention;

FIG. 9 is a front view of the rotor slot armor component illustrated in FIG. 8;

FIG. 10 is a perspective view of the rotor slot armor component illustrated in FIGS. 8 and 9;

FIG. 11 is a partial side view of a rotor slot armor component having an internal skeleton in accordance with another exemplary embodiment of the present invention;

FIG. 12 is a schematic diagram of a profile extrusion system in accordance with an exemplary embodiment of the present invention;

FIG. 13 is a front view of an exemplary spider plate of the profile extrusion system illustrated in FIG. 12;

FIG. 14 is a front view of an exemplary pre-land plate of the profile extrusion system illustrated in FIG. 12;

FIG. 15 is a front view of an exemplary land plate of the profile extrusion system illustrated in FIG. 12;

FIG. 16 is a view showing details of a portion of the exemplary spider plate illustrated in FIG. 13 which is encircled by circle 160;

FIG. 17 is a chart depicting tensile creep of rotor slot armor formed by 10% glass-filled Ultem;

FIG. 18 is a chart depicting tensile creep of rotor slot armor formed by 30% glass-filled PEEK; and

FIG. 19 is a chart depicting compressive creep of rotor slot armor formed by a PEEK material.

### DETAILED DESCRIPTION

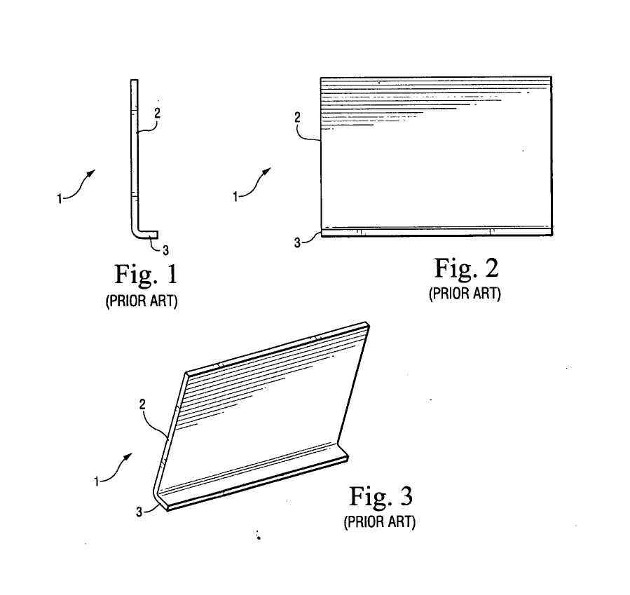

FIGS. 1-3 illustrate a known L-shaped rotor slot armor component 1. Leg portions 2 and 3 of rotor slot armor component 1 are disposed perpendicularly to each other. The thickness of rotor slot armor component 1 is uniform.

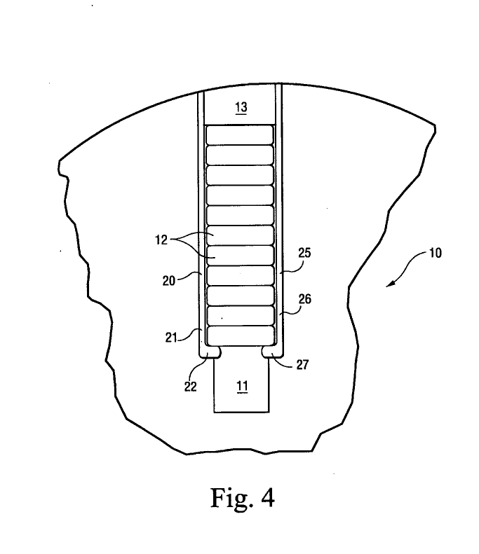

FIG. 4 illustrates a partial view of a rotor 10 of a dynamo-electric machine in accordance with an exemplary embodiment of the present invention. Rotor 10 includes a plurality of axial slots 11, one of which is illustrated. Each of the axial slots 11 receives field coils 12 which are utilized to create a flux magnetic field. This flux magnetic field interacts with stator windings (not shown) of the dynamo-electric machine upon the rotation of rotor 10 to generate electric power.

Rotor slot armor mechanically and electrically isolates field coils 12 from the body of rotor 10. The rotor slot armor includes rotor slot armor components 20 and 25. Rotor slot armor component 20 includes long leg portion 21 and short leg portion 22 disposed perpendicularly to long leg portion 21. Rotor slot armor component 25 includes long leg portion 26 and short leg portion 27 disposed perpendicularly to long leg portion 26. Long leg portions 21 and 26 of respective rotor slot armor components 20 and 25 provide insulation to opposing sides of field coils 12 to withstand electrical, mechanical and thermal forces induced during operation of rotor 10. Short leg portions 22 and 27 of respective rotor slot armor components 20 and 25 extend at a radially innermost one of field coils 12. Creepage block 13 is arranged within slot 11 to insulate the radially outermost one of field coils 12 and resist the radially outward forces exerted on field coils 12 when rotor 10 is in operation. As can be seen in FIG. 4, no sub-slot cover is necessary in this exemplary embodiment of the present invention.

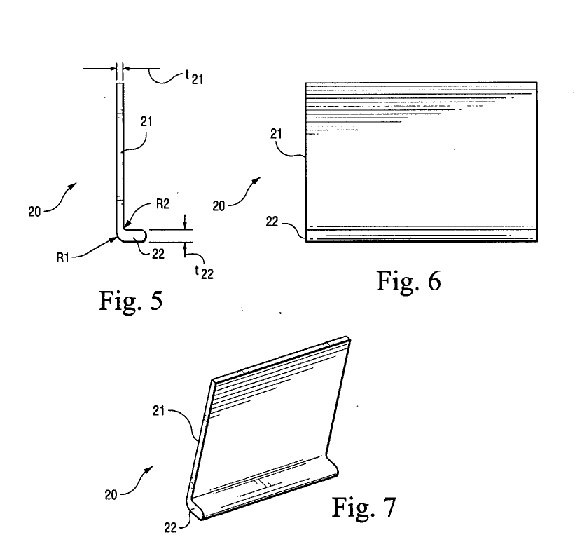

FIGS. 5-7 illustrate details of the shape and configuration of rotor slot armor component 20, although it will be understood that identical comments apply to rotor slot armor component 25. The thickness of short leg portion 22 of rotor slot armor component 20 is greater than the thickness of long leg portion 21. That is, thickness t₂₂ is greater than thickness t₂₁. Leg portions 21 and 22 are integrally connected to each other at a portion of rotor slot armor component 20 which has rounded edges as defined by radiuses R1 and R2. Leg portions 21 and 22 extend perpendicularly to each other.

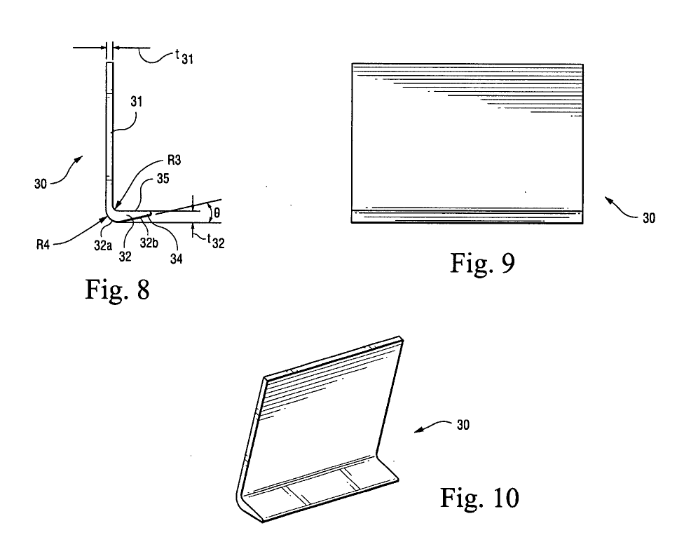

FIGS. 8-10 illustrate details of the shape and configuration of rotor slot armor component 30 in accordance with another exemplary embodiment of the present invention. Rotor slot armor component 30 includes long leg portion 31 and short leg portion 32 integrally connected at a portion of rotor slot armor component 30 whose shape is defined by radiuses R3 and R4. Leg portion 32 includes a connection portion 32a which is integrally connected to leg portion 31 and a tip portion 32b which extends away from connection portion 32a. The thickness of connection portion 32a and at least a portion of tip portion 32b is greater than the thickness of leg portion 31. For example, thickness t₃₂ is greater than thickness t₃₁. The thickness of tip portion 32b tapers off (i.e., lessens) as it extends away from connection portion 32a. Surface 35 of leg portion 32 extends perpendicularly to the direction of leg portion 31. However, surface 34 of tip portion 32b, arranged on the opposite side of surface 35, extends at a non-perpendicular angle to leg portion 31. For example, surface 34 extends at an angle Î, (e.g., 13Â°). Through its shape and configuration, and in particular the shape and configuration of leg portion 32, rotor slot armor component 30 may further reduce the electric stress on rotor 10. The strength of the material to withstand breakage may therefore be enhanced.

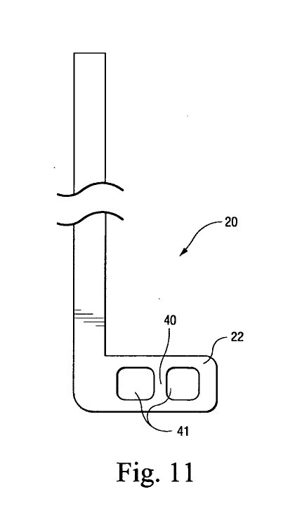

FIG. 11 illustrates a leg portion 22 (or 27) of rotor slot armor component 20 (or 25) which includes an internal skeleton 40 in accordance with another exemplary embodiment of the present invention. Skeleton 40 provides structural and dimensional stability for rotor slot armor component 20 and defines hollow portions 41 within rotor slot armor component 20. Alternatively, leg portion 22 (or 25 or 30) may be completely filled as illustrated in FIGS. 4-10 to ensure structural and dimensional stability. The material filling leg portion 22 may be the same material forming other portions of slot rotor armor component 20. That is, a monolithic material may form the entire rotor slot armor component 20. This monolithic material may be formed by a profile extrusion process as discussed in detail below.

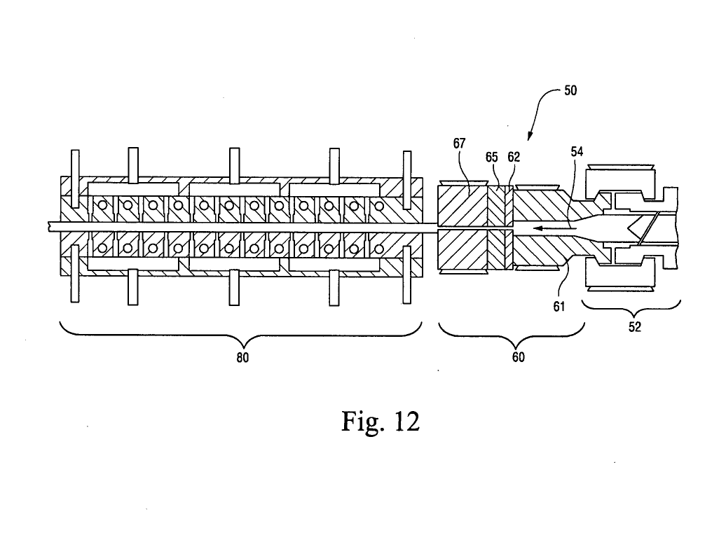

FIG. 12 is a schematic diagram of a profile extrusion system used for processing a material to form profile extruded rotor slot armor component 20 (or component 30) in accordance with an exemplary embodiment of the present invention. A material processed by profile extrusion system 50 flows in a direction indicated by arrow 54. Profile extrusion system 50 includes an extruder 52, a die 60 and a calibrator 80. Die 60 includes a die reservoir 61, spider plate 62, pre-land 65 and land 67.

In operation, extruder 52 receives raw materials such as pellets of raw polymer and optionally a powder of filler material such as glass (e.g., chopped glass fiber or glass beads) which are placed in a hopper. A screw element(s) arranged within a barrel of extruder 52 is rotated in order to mix the raw materials. While being conveyed through the barrel of extruder 52, the raw materials are heated so that they are transformed from a solid state into a molten state. The molten material is then conveyed and forced at high pressure through die 60. In particular, the molten material is conveyed through die reservoir 61 to spider plate 62.

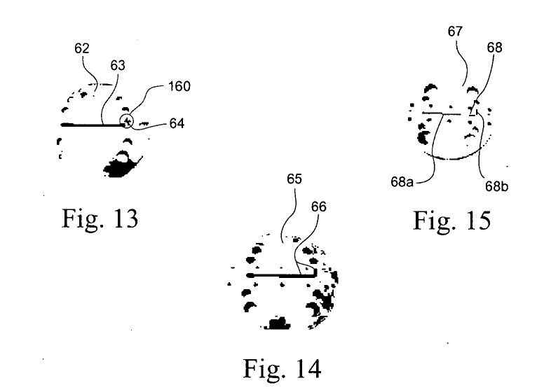

FIG. 13 illustrates a front view of an exemplary spider plate 62. Spider plate 62 includes a number of slots through which the molten material may pass. These slots include a long thin slot 63 and a cross-shaped slot 64. The molten material passing through slots 63 and 64 of spider plate 62 is conveyed to pre-land 65.

FIG. 14 illustrates a front view of an exemplary pre-land 65. Pre-land 65 includes a slot 66 which provides shaping to the molten material passing therethrough. Specifically, material passing through slots 63 and 64 of spider plate 62 is conveyed through slot 66 of pre-land 65. After passing through slot 66 of pre-land 65, the molten material is conveyed to land 67.

FIG. 15 illustrates a front view of an exemplary land 67. Land 67 includes a slot 68 which provides a final profile shape to the molten material. Specifically, slot 68 includes a long thin slot portion 68a and a short wide slot portion 68b arranged at an angle to slot portion 68a so that molten material passing through slot 68 will have an L-shaped profile.

After passing through land 67, the profile shaped material enters calibrator 80. Calibrator 80 cools the shaped material and fine tunes the final dimensions of the profile extruded rotor slot armor component 20 output by the profile extrusion system.

It is beneficial for the material to exit land 67 at a substantially uniform rate. For example, it is beneficial for the flow rate of the material exiting slot portion 68a to match the flow rate of the material exiting slot portion 68b so that the molten material exiting slot 68 will not twist or bend over (after exit). If the respective flow rates of the material exiting slot portions 68a and 68b are not uniform, the material may bend and twist over after leaving slot 68 and thus the desired profile-extruded shape will not be obtained.

Because the dimensions of slot portion 68a are different than the dimensions of slot portion 68b, the molten material exiting these respective slot portions will tend to flow at different rates. In particular, the flow resistance offered by wide slot portion 68b is less than that offered by thin slot portion 68a. If an unregulated amount of molten material was provided to slot 68, the material may not completely fill up and flow out of thin slot portion 68a. The flow rate of material exiting thin slot portion 68a would therefore be lower than the flow rate of material exiting wide slot portion 68b because the flow resistance provided by thin slot 68a is greater than that offered by wide slot 68b. Because the respective flow rates are non-uniform, the material may bend and twist after leaving slot 68 of land 67 and thus the desired profile shape would not be obtained.

In order to ensure that the respective flow rates from slot portions 68a and 68b are uniform, additional flow resistance must be provided to that portion of the material that will pass through slot portion 68b. That is, the flow of molten material provided to wide slot portion 68b must be slowed (or the flow rate of material provided to slot portion 68a must be increased) so that the flow rate of material exiting from all portions of slot 68 (e.g., slot portions 68a and 68b) is uniform.

In order to slow the flow rate of material exiting slot portion 68b, the of material being provided to slot portion 68b is slowed. The flow rate of material being provided to slot portion 68b may be slowed through the use of spider plate 62 which is located upstream from land 68.

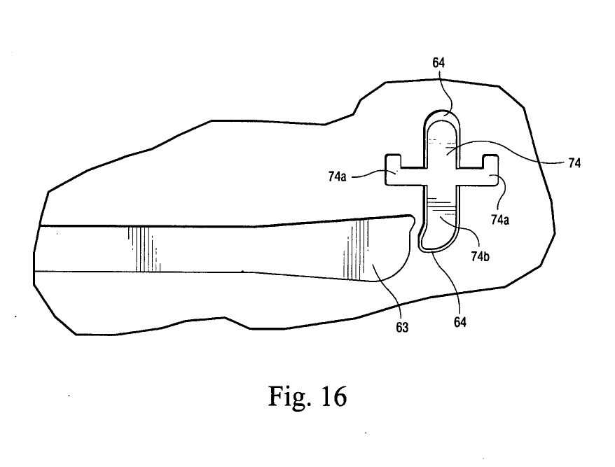

FIG. 16 illustrates details of a portion of spider plate 62. Spider plate 62 includes slot 64. At least some of the material passing through slot 64 of spider plate 62 will ultimately be provided to slot portion 68b. That is, slot 64 and slot portion 68b are positioned so that at least some of the material exiting slot 64 ultimately enters slot portion 68b via slot 66 of pre-land 65. By controlling the flow rate of material passing through slot 64 of spider plate 62 (upstream of land 67), the flow rate of material entering slot 68b may be controlled and thus the flow rate of material exiting slot 68b may be controlled.

As can be seen in detail from FIG. 16, mandrel 74 is inserted and held in slot 64 of spider plate 64. Specifically, mandrel 74 includes two horizontally-extending arms 74a which are inserted tightly in a correspondingly shaped portion of slot 64 so that mandrel 74 is held within slot 64. The two arms 74a extend from a body portion 74b of mandrel 74. The dimensions on the top, bottom and lateral sides of body portion 74b, however, are not as extensive as the corresponding portions of slot 64. Accordingly, slot 64 still contains openings (e.g., see the top and the bottom portions of slot 64) through which molten material may pass. The rate at which molten material passes through slot 64 is controlled by the size of body portion 74b. For example, in order to increase the flow rate through slot 64, the size of the top and bottom portions of body portion 74b can be decreased so that the flow openings defined in slot 64 will be larger.

The position of slot 64 having mandrel 74 inserted therein is aligned with slot portion 68b of land 67. Slot 63 of spider plate 62 is aligned with slot portion 68a of land 67. At least some of the molten material originating from slot 63 of spider plate 62 will therefore pass through slot 66 of pre-land 65 and then to slot portion 68a of land 67. However, the flow rate of material exiting from slot 64 is restricted by mandrel 74 (body portion 74b in particular) so that the flow rate of material exiting from slot 64 will be slowed even before it reaches slot portion 68b. Since the flow of material reaching slot portion 68b is slowed, the flow rate of material exiting slot portion 68b will be slowed. The flow rate of material flowing out of slot portion 68b can thus be slowed so that it matches the flow rate of material exiting slot portion 68a. A uniform flow velocity of material exiting slot portions 68a and 68b may therefore be obtained. Undesired twisting and deformation of the molten material exiting slot 68 may therefore be avoided and the desired profile shape may be obtained.

The final profile extruded product (i.e., rotor slot armor component 20) contains the shape defined by slot 68 of land 67. As it is being cooled by calibrator 80, the product may be cut to length.

By utilizing the profile extrusion manufacturing process described above, rotor slot armor components can be formed in a large variety of shapes and thicknesses. For example, the L-shaped profile of rotor slot armor components 20, 25 or 30 may be formed to accurate and precise dimensions. Utilizing the profile extrusion process to manufacture the rotor slot armor components also enables these components to have a relatively high flexural modulus, flexural strength, angular strength, electrical creepage and dielectric strength. For example, since the profile extruded layer may be a uniform-composition (monolithic) layer, voids, defects and weak inter-layer interfaces can be avoided, thereby provided a stronger dielectric strength. The rotor slot armor materials formed using a profile extrusion process also provide a lower moisture absorption, high dielectric strength and electrical creepage as well as improved solvent resistance. This improved solvent resistance reduces electrical failures due to chemical contamination of the profile extruded material forming the rotor slot armor components.

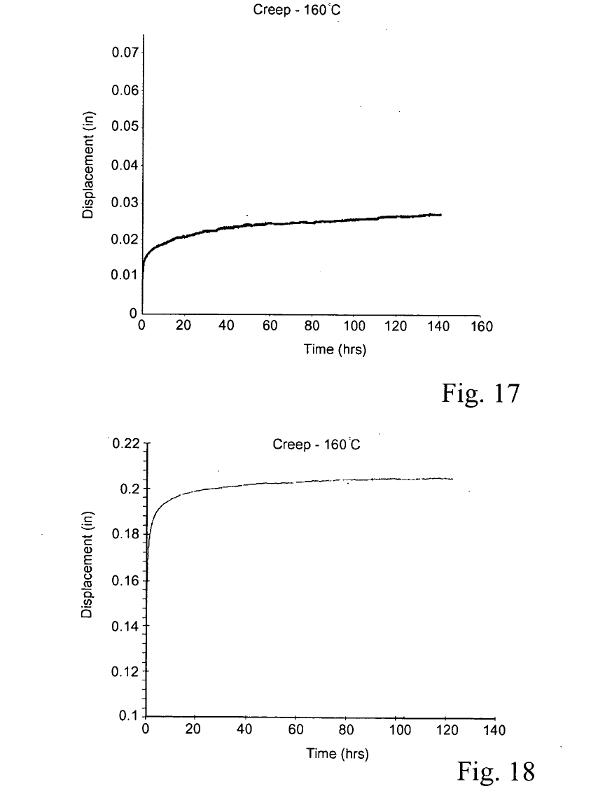

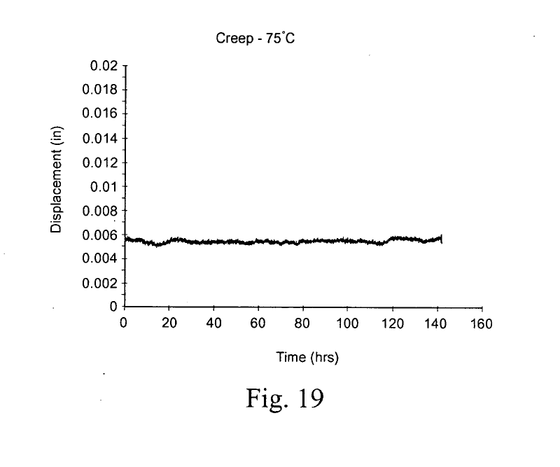

While any high temperature thermoplastic (Tg>200Â° C.) that is extrudable, thermoformable, injection-moldable or compression-moldable may be used to form the profile-extruded rotor slot armor components, the inventors have discovered that glass-filled Ultem, unfilled Ultem, glass-filled PEEK (polyetheretherketone) or unfilled PEEK provide particularly favorable characteristics. Specifically, the inventors have found that Ultem having a glass-fill between and including 0% and 30% (0% â [symbol] glass-fill â [symbol] 30%) and PEEK having a glass-fill between and including 0% and 30% (0% â [symbol] glass-fill â [symbol] 30%) provide preferable mechanical, electrical and/or thermal properties for use as a rotor slot armor material. Moreover, the inventors have also found that unfilled Ultem (e.g., 0% glass-filled Ultem) and unfilled PEEK (e.g., 0% glass-filled PEEK) provide preferable mechanical, electrical and/or thermal properties for use as a rotor slot armor material. The tables provided below provide details of the favorable mechanical, electrical and thermal characteristics provided by the profile extruded Ultem and PEEK materials forming the rotor slot armor in accordance with the present invention. For example, the below tables provide detailed specifications on the following characteristics of profile extruded Ultem and PEEK materials: angular cracking, flexural strength, flexural modulus, thermal endurance, impact resistance and thermal conductivity, dielectric strength, electrical creepage and voltage impulse resistance, flatness, water absorption, shrinkage and tensile creep. Moreover, FIGS. 17 and 18 are charts illustrating the tensile creep of 10% glass-filled Ultem and 30% glass-filled PEEK, respectively, and FIG. 19 is a chart illustrating the compressive creep of a PEEK material, each of which may be utilized to form rotor slot armor in accordance with exemplary embodiments of the present invention.

Angular Cracking

Benchmark: Current material—1.5 lb @ 0.31 inches

| Material | lbs @ inches |
|---|---|
| 10% Glass filled PEEK | 10.5 lb @ 0.06″ |
| 30% Glass filled PEEK | 11 lb @ 0.22″ |
| 30% Glass filled PEEK | 107 lb @ 0.35″ |
| Unfilled Ultem | 32 lb @ 0.23″ |
| 10% Glass filled Ultem | 21 lb @ 0.22″ |
| 30% Glass filled Ultem | 7 lb @ 0.15″ |

Flexural Strength

Functional Spec: 30,000 psi @ rt (room temperature) and 15,000 psi @ 160Â° C.

| Material | @ rt | @ 160Â ° C. |
|---|---|---|
| Inj molded 30% glass PEEK | 24,000 | 13,000 |
| Extruded 30% glass PEEK | 21,000 | |
| Profile extruded 10% glass PEEK | 15,000 | |
| Profile extruded 30% glass PEEK | 18,000 | |
| Profile extruded unfilled Ultem | 14,000 | |
| Profile extruded 10% glass Ultem | 17,000 | |
| Profile extruded 20% glass Ultem | 25,000 | 15,600 |
| Profile extruded 30% glass Ultem | 13,000 | |

Flexural Modulus

Functional Spec: 800,000 psi @ rt and 600,000 @160Â° C.

| Material | @rt | @ 160Â ° C. |
|---|---|---|
| Inj molded 30% glass PEEK | 600,000 | 400,000 |
| Extruded 30% glass PEEK | 765,000 | |
| Profile extruded 10% glass PEEK | 348,000 | |
| Profile extruded 30% glass PEEK | 586,000 | |
| Profile extruded unfilled Ultem | 216,000 | |
| Profile extruded 10% glass Ultem | 309,000 | |
| Profile extruded 20% glass Ultem | 890,000 | 704,000 |
| Profile extruded 30% glass Ultem | 410,000 | |

Thermal Endurance

Functional Spec: hours @160Â° C.

| Material | Flex Strength, psi | Flex Mod, psi |
|---|---|---|
| Inj molded 30% glass PEEK | 13,000: 7 weeks | 267,000 |
| Extruded 30% glass PEEK | 25,000: 7 weeks | 700,000 |
| Profile extruded 10% glass PEEK | 20,000: 2 weeks | 268,000 |
| Profile extruded 30% glass PEEK | 22,000: 2 weeks | 580,000 |
| Profile extruded unfilled Ultem | 17,000: 3 weeks | 213,000 |
| Profile extruded 10% glass Ultem | 18,000: 3 weeks | 271,000 |
| Profile extruded 30% glass Ultem | 17,000: 3 weeks | 432,000 |

Impact Resistance and Thermal Conductivity

Benchmark: 10 inlbs min
10% glass PEEK: 60 inlbs
30% glass PEEK: 40 inlbs
Unfilled Ultem: 60 inlbs
10% glass Ultem: 40 inlbs
30% glass Ultem: 60 inlbs
Benchmark: 0.27 W/mK
10% glass Ultem: 0.18
30% glass Ultem: 0.21
30% glass PEEK: 0.28

Dielectric Strength

Benchmark: 13 kV as received, 6.5-7.5 after impact

| Material | B/D as rec, kV | B/D after impact, kV |
|---|---|---|
| 30% Ultem, CRD extruded | 18 | 18 |
| 20% Ultem, CRD extruded | 19 | 19 |
| 30% PEEK, inj molded | 34 | 28 |
| 30% PEEK, profile extruded | 26 | 27 |
| 30% Ultem, profile extruded | 25 | 23 |

Electrical Creepage & Voltage Impulse Resistance

Benchmark: 6.5 kV for 60 seconds & 7.5 kV for 50 hrs minimum

| Material | Creepage, kV | VIR, hours |
|---|---|---|
| 30% Ultem, CRD extruded | 7 | 500 |
| 20% Ultem, CRD extruded | 7 | 500 |

Flatness

| Material | Height (mm) with 8 g weight |
|---|---|
| 10% glass filled PEEK | 6 |
| 30% glass filled PEEK | 7 |
| Unfilled Ultem | 11 |
| 10% glass filled Ultem | 10.5 |
| 30% glass filled Ultem | 8 |

Water Absorption

Benchmark: 8.0% maximum absorption

| Material | % Absorption | Time of exposure |
|---|---|---|
| 30% glass PEEK(profile extruded) | 0.6% | 8 weeks |
| 30% glass PEEK(inj molded) | 0.25% | 7 weeks |
| Unfilled Ultem | 1.4% | 7 weeks |
| 20% glass Ultem | 1.1% | 6 weeks |
| 30% Ultem | 1.1% | 8 weeks |

Shrinkage

Benchmark: 0.1% max, cross+length

| Material | % Cross | % Length |
|---|---|---|
| 30% glass Ultem (CRD) | 0.13 | 0.08 |
| 30% glass Ultem (Profile extruded) | 0.26 | 0.4 |
| 30% glass PEEK (inj molded) | +0.21 | +0.08 |
| 30% glass PEEK (CRD HT) | 0.65 | 0.27 |
| 30% glass PEEK (CRD LT) | 1.5 | 0.56 |
| 30% glass PEEK (Profile extruded) | 0.54 | 1.01 |

Tensile Creep: 160C, 75C, rt

Â. 160 C.

30% glass PEEK: 123 hrs @ 41 lbs, 0.2″
10% glass PEEK: 21 sec @ 21 lbs, 0.98″
10% glass Ultem: 141 hrs @ 39 lbs, 0.026″
Unfilled Ultem: 134 hrs @ 45 lbs, 0.08″

While the above described exemplary embodiments are directed to a profile extrusion manufacturing process, other techniques are possible such as techniques involving high temperature thermosets that are resin transfer moldable.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A slot armor component for use in a rotor of a dynamo-electric machine, the slot armor component comprising a profile extruded material having a first leg portion and a second leg portion disposed at an angle to the first leg portion, the second leg portion being shorter and thicker than the first leg portion.

2. A slot armor component as in claim 1, wherein the material is glass-filled polyetheretherketone (PEEK).

3. A slot armor component as in claim 2, wherein the material is less than or equal to 30% glass-filled polyetheretherketone (PEEK).

4. A slot armor component as in claim 1, wherein the material is unfilled polyetheretherketone (PEEK).

5. A slot armor component as in claim 1, wherein the material is glass-filled Ultem.

6. A slot armor component as in claim 5, wherein the material is less than or equal to 30% glass-filled Ultem.

7. A slot armor component as in claim 1, wherein the material is unfilled Ultem.

8. A slot armor component as in claim 1, wherein the second leg portion includes (i) a connection portion integrally connected to the first leg portion, and (ii) a tip portion integrally connected to the connection portion, the tip portion having a width which tapers as the tip portion extends away from the connection portion.

9. A slot armor component as in claim 1, wherein the second leg portion includes (i) a first surface which extends perpendicularly to the first leg portion, and (ii) a second surface, opposite to the first surface, which extends at an angle less than perpendicular to the first leg portion.

10. A slot armor component as in claim 1, wherein the second leg portion includes an internal skeleton structure.

11. A slot armor component as in claim 1, wherein the second leg portion is completely filled by the profile extruded material.

12. A slot armor component as in claim 10, wherein the internal skeleton structure defines at least one hollow volume within the second leg portion.

13. A method of forming a slot armor component for use in a rotor, the method comprising:
producing a material utilizing a profile extruded process; and shaping the profile extruded material into a first leg portion and a second leg portion disposed at an angle to the first leg portion, the second leg portion being shorter and thicker than the first leg portion.

14. A method as in claim 13, wherein the material is glass-filled polyetheretherketone (PEEK).

15. A method as in claim 14, wherein the material is less than or equal to 30% glass-filled polyetheretherketone (PEEK).

16. A method as in claim 13, wherein the material is unfilled polyetheretherketone (PEEK).

17. A method as in claim 13, wherein the material is glass-filled Ultem.

18. A method as in claim 17, wherein the material is less than or equal to 30% glass-filled Ultem.

19. A method as in claim 13, wherein the material is unfilled Ultem.

20. A method as in claim 13, wherein the second leg portion includes (i) a connection portion integrally connected to the first leg portion, and (ii) a tip portion integrally connected to the connection portion, the tip portion having a width which tapers as the tip portion extends away from the connection portion.

21. A method as in claim 13, wherein the second leg portion includes (i) a first surface which extends perpendicularly to the first leg portion, and (ii) a second surface, opposite to the first surface, which extends at an angle less than perpendicular to the first leg portion.

22. A method as in claim 13, wherein the second leg portion includes an internal skeleton structure.

23. A method as in claim 13, wherein the second leg portion is completely filled by the profile extruded material.

24. A method as in claim 22, wherein the internal skeleton structure defines at least one hollow volume within the second leg portion.

25. A slot armor material for use in a rotor of a dynamo-electric machine comprising glass-filled polyetheretherketone (PEEK).

26. A slot armor material as in claim 25, wherein the glass-filled polyetheretherketone (PEEK) is less than or equal to 30% glass-filled polyetheretherketone (PEEK).

27. A slot armor material as in claim 25, wherein the material is a profile extruded material.

28. A slot armor material as in claim 27, wherein the profile extruded material includes a first leg portion and a second leg portion disposed at an angle to the first leg portion, the second leg portion being shorter and thicker than the first leg portion.

29. A slot armor material as in claim 28, wherein the second leg portion includes (i) a connection portion integrally connected to the first leg portion, and (ii) a tip portion integrally connected to the connection portion, the tip portion having a width which tapers as the tip portion extends away from the connection portion.

30. A slot armor material as in claim 28, wherein the second leg portion includes (i) a first surface which extends perpendicularly to the first leg portion, and (ii) a second surface, opposite to the first surface, which extends at an angle less than perpendicular to the first leg portion.

31. A slot armor material as in claim 28, wherein the second leg portion includes an internal skeleton structure.

32. A slot armor material for use in a rotor of a dynamo-electric machine comprising an unfilled polyetheretherketone (PEEK).

33. A slot armor material as in claim 32, wherein the material is a profile extruded material.

34. A slot armor material as in claim 33, wherein the profile extruded material includes a first leg portion and a second leg portion disposed at an angle to the first leg portion, the second leg portion being shorter and thicker than the first leg portion.

35. A slot armor material as in claim 34, wherein the second leg portion includes (i) a connection portion integrally connected to the first leg portion, and (ii) a tip portion integrally connected to the connection portion, the tip portion having a width which tapers as the tip portion extends away from the connection portion.

36. A slot armor material as in claim 34, wherein the second leg portion includes (i) a first surface which extends perpendicularly to the first leg portion, and (ii) a second surface, opposite to the first surface, which extends at an angle less than perpendicular to the first leg portion.

37. A slot armor material as in claim 34, wherein the second leg portion includes an internal skeleton structure.

38. A slot armor material for use in a rotor of a dynamo-electric machine comprising glass-filled Ultem.

39. A slot armor material as in claim 38 wherein the glass-filled Ultem is less than or equal to 30% glass-filled Ultem.

40. A slot armor material as in claim 38, wherein the material is a profile extruded material.

41. A slot armor material as in claim 40, wherein the profile extruded material includes a first leg portion and a second leg portion disposed at an angle to the first leg portion, the second leg portion being shorter and thicker than the first leg portion.

42. A slot armor material as in claim 41, wherein the second leg portion includes (i) a connection portion integrally connected to the first leg portion, and (ii) a tip portion integrally connected to the connection portion, the tip portion having a width which tapers as the tip portion extends away from the connection portion.

43. A slot armor material as in claim 41, wherein the second leg portion includes (i) a first surface which extends perpendicularly to the first leg portion, and (ii) a second surface, opposite to the first surface, which extends at an angle less than perpendicular to the first leg portion.

44. A slot armor material as in claim 41, wherein the second leg portion includes an internal skeleton structure.

45. A slot armor material for use in a rotor of a dynamo-electric machine comprising an unfilled Ultem.

46. A slot armor material as in claim 45, wherein the material is a profile extruded material.

47. A slot armor material as in claim 46, wherein the profile extruded material includes a first leg portion and a second leg portion disposed at an angle to the first leg portion, the second leg portion being shorter and thicker than the first leg portion.

48. A slot armor material as in claim 47, wherein the second leg portion includes (i) a connection portion integrally connected to the first leg portion, and (ii) a tip portion integrally connected to the connection portion, the tip portion having a width which tapers as the tip portion extends away from the connection portion.

49. A slot armor material as in claim 47, wherein the second leg portion includes (i) a first surface which extends perpendicularly to the first leg portion, and (ii) a second surface, opposite to the first surface, which extends at an angle less than perpendicular to the first leg portion.

50. A slot armor material as in claim 47, wherein the second leg portion includes an internal skeleton structure.

51. A profile extrusion system for profile extruding a material, the system comprising:
an extruder for melting the material;
a profile extrusion die operatively coupled to the extruder so that the die receives the material melted by the extruder, the die comprising:
a plate having a first slot and a second slot defined therein, the material passing through the first slot and the second slot;
a mandrel inserted into the second slot of the plate for controlling a flow rate of the material passing through the second slot; and
a land having a profile-shaped slot defined therein for providing a profile shape to the material that has passed through the first and second slots of the plate; and
a calibrator for cooling the material shaped by the land.

52. A profile extrusion system as in claim 51 wherein the mandrel slows the flow rate of the material passing through the second slot so that the material passes through all portions of the profile-shaped slot of the land at a uniform flow rate.

53. A profile extrusion system as in claim 51 wherein the profile-shaped slot of the land has a first slot portion and a second slot portion disposed at an angle to the first slot portion, the second slot portion being wider and shorter than the first slot portion; and
the first slot of the plate is aligned with the first slot portion of the land so that at least some of the material that has passed through the first slot passes through the first slot portion, and the second slot of the plate is aligned with the second slot portion of the land so that at least some of the material that has passed through the second slot passes through the second slot portion.

54. A profile extrusion system as in claim 53 wherein the mandrel slows the flow rate of the material passing through the second slot of the plate so that the material passes through the first and second slot portions at a uniform flow rate.
